(19) United States
(12) Patent Application Publication
(10) Pub. No.: US 2016/0155522 A1
(43) Pub. Date: Jun. 2, 2016

(54) APPARATUS AND METHOD FOR INDICATING POSITION OF CONTROL ROD IN NUCLEAR REACTOR

(71) Applicant: WOOJIN INC., Gyeonggi-do (KR)

(72) Inventors: Hoon Bin Hong, Gyeonggi-do (KR); Min Ho Baek, Daegu (KR)

(21) Appl. No.: 14/918,030

(22) Filed: Oct. 20, 2015

(30) Foreign Application Priority Data
Nov. 27, 2014 (KR) 10-2014-0167532

(51) Int. Cl. G21C 17/12

(52) U.S. Cl. CPC G21C 17/12

(57) ABSTRACT

Provided are an apparatus and method for indicating a position of a control rod in a nuclear reactor, in which a plurality of trapezoid unevenness are disposed on a control rod driving rod, and a signal pattern with respect to distances between the unevenness and sensors are analyzed to measure a position of the control rod by using the less number of sensors, e.g., three sensors and a method for indicating the position of the control rod by using the same.

### CROSS-REFERENCE TO RELATED APPLICATION

This application claims priority to and the benefit of Korean Patent Application No. 10-2014-0167532, filed on Nov. 27, 2014, the disclosure of which is incorporated herein by reference in its entirety.

### FIELD OF THE INVENTION

The present invention relates to an apparatus and method for indicating a position of a control rod in a nuclear reactor, and more particularly, to an apparatus for indicating a position of a control rod in a nuclear reactor, in which a plurality of trapezoid unevenness are disposed on a control rod driving rod, and a signal pattern with respect to distances between the unevenness and sensors are analyzed to measure a position of the control rod by using the less number of sensors, e.g., three sensors, and a method for indicating the position of the control rod by using the same.

### BACKGROUND OF THE INVENTION

A nuclear reactor of a nuclear power plant heats primary coolant that circulates therein at a predetermined high temperature having a design value on the basis of thermal energy that is generated through chain reaction of nuclear fission of a nuclear fuel. The primarily heated coolant is heat-exchanged again with secondary coolant in a steam generator to generate high-temperature high-pressure steam. The generated high-temperature high-pressure steam drives a turbine generator to generate electricity energy.

That is, the thermal energy within the nuclear reactor changes into the electricity energy. Here, a control rod may be used to control an amount of thermal energy within a limited range. Several control rods may be assembled with each other to form an assembly. The assembly is called a control rod assembly. The control rod assembly vertically moves with respect to a core in the nuclear reactor to control the nuclear reaction. A device for driving the control rod assembly is called a control rod drive mechanism (CRDM).

The CRDM is connected to a reactor head that is disposed on an upper portion of the nuclear reactor. The CRDM drives an extension shaft connected to the control rod assembly to control movement of the assembly without directly controlling the control rod assembly.

As described above, a device for detecting a position of the control rod, which is very important in control of the nuclear fission reaction of the core of the nuclear reactor may be a control rod position detection device. A reed switch position transmitter (RSPT) in which a reed switch is adopted as a detection sensor of the control rod position detection device to perform voltage distribution by using a resistor is being used in Korean Standard Nuclear Power Plant (KSNP) that is operating at present.

FIG. 1 is a cross-sectional view of a conventional control rod drive mechanism and a position indicator upper housing that are disclosed in Prior Art 1, and FIG. 2 is a schematic view of a reed switch-type position indicator according to the related art. As illustrated in FIGS. 1 and 2, a control rod position indication sensor module 26 is separated and spaced along a housing 24 on a CRDM coil. Substantially, a control rod drive rod 20 includes a magnetizing part 40 that moves over a full length span of the control rod position indication sensor module 26. In FIG. 1, a reliable linear relationship is provided between the position and electric resistance of the magnetizing unit 40 of the control rod drive rod 20 by using the sensor module 26 mounted within a metallic or ceramic material. The sensor module 26 may also provide an absolute position and moving direction indication. In the current embodiment, a reed switch position transmitter including a reed switch provided in a network of distributor mounted on a non-metallic terminal strip that is sealed within a stainless steel housing 42 is provided. The stainless steel housing 42 provides an output voltage signal that is proportional to the position of the control rod drive rod 20 when the control rod drive rod mounted on the CRDM moves by the CRDM.

In the current embodiment, the sensor module 26 includes a plurality of reed switches, for example, 97 sets of reed switches at a predetermined distance. The reed switches may be connected parallel to each other through resistors that are disposed between connection parts. For example, the sensor module 26 may be connected parallel to two nickel-chrome resistance rods 48 that are separated by a ceramic insulator separator 46. The nickel-chrome resistance rod 48 is connected to an ohm meter 50 for indicating a position of the control rod.

However, as described above, in the control rod indication device of the nuclear reactor according to the related art, it is necessary to check an effect due to a variation in ampere-turns (AT) value. In addition, since a limiting temperature of a typical resistor is less than a temperature of about 350° C., a detection error may increase if the reed switch is applied to the inside of the core that increases to a temperature greater than the limiting temperature.

Furthermore, a large number of reed switches may be required, and thus the device may be complicated.

### PRIOR ART DOCUMENTS

(Patent Document 1) Korean Patient Publication No. 10-2013-132943 (Title of The invention: Position Indication System Of Nuclear Control Rod)
(Patent Document 2) Japanese Patient Application Laid-Open No. 5-134084 (Title of The invention: Position Indication Device For Control Rod Drive Mechanism)
(Patent Document 3) Japanese Patient Application Laid-Open No. 10-239476 (Title of The invention: Position Indication Device For Control Rod Drive Mechanism)
(Patent Document 4) European Patent Registration No. 0871962 (EP 0871962B1) (Title of The invention: A Method and system for compensating rod position indication system for non-linearity)

### SUMMARY OF THE INVENTION

Accordingly, the present invention is directed to an apparatus and method for indicating a position of a control rod in a nuclear reactor that substantially obviate one or more problems due to limitations and disadvantages of the related art. An object of the present invention is to provide an apparatus for indicating a position of a control rod in a nuclear reactor, in which a plurality of trapezoid unevenness are disposed on a control rod driving rod, and a signal pattern with respect to distances between the unevenness and sensors are analyzed to measure a position of the control rod by using the less number of sensors, e.g., three sensors and a method for indicating the position of the control rod by using the same.

In one embodiment of the present invention, an apparatus for indicating a position of a control rod in a nuclear reactor, which includes a control rod drive rod that is connected to a control rod assembly so as to be elevated by a control rod drive coil includes: the control rod drive rod on which an oblique unevenness is continuously disposed along a longitudinal direction of a circumferential surface thereof; at least three drive rod position detection sensors that detect a convex portion, a concave portion, and an oblique portion of the oblique unevenness at the same time; and a control unit analyzing a pattern of detection signals that are outputted from the drive rod position detection sensors at the same time to indicate the position of the control rod.

The oblique unevenness may include an unevenness having a trapezoid shape, the convex portion, the concave portion, and the oblique portion may correspond to a convex surface, a concave surface, and an oblique surface of the trapezoid shape, respectively, and each of lengths of the convex surface and the concave surface and a vertical length of the oblique surface may be equal to each of distances between the three drive rod position detection sensors.

A horizontal surface instead of the oblique surface may be disposed on a circumferential surface of the control rod drive rod, which is disposed directly above a lower end surface of the control rod drive rod, and a circumferential surface of the control rod drive rod, which is disposed directly below an upper end surface of the control rod drive rod may have a length greater than that of the convex surface.

The three control rod position detection sensors may be constituted by an exclusive optical sensor, magnetic field sensor, or ultrasonic sensor or a combination thereof.

In another embodiment of the present invention, a method for indicating a position of a control rod in a nuclear reactor, which is performed by a control unit in the nuclear reactor including: a control rod drive rod that is connected to a control rod assembly so as to be elevated by a control rod drive coil and on which an oblique unevenness is continuously disposed along a longitudinal direction of a circumferential surface thereof; and at least three drive rod position detection sensors that detect a convex portion, a concave portion, and an oblique portion of the oblique unevenness at the same time includes: a process (a) of checking a pattern of three signals that are outputted from the drive rod position detection sensors at the same time; and a process (b) of indicating whether the control rod is elevated on the basis of a kind of signal pattern and variation of the signal pattern.

The signal pattern when the control rod drive rod is disposed at the uppermost end or lowermost end may be different from that when the signal pattern is not disposed at the uppermost end or lowermost end.

An absolute position of the control rod may be grasped on the basis of the number of variation of the signal pattern.

### BRIEF DESCRIPTION OF THE DRAWINGS

FIG. 1 is a cross-sectional view of a control rod drive mechanism and a position indicator upper housing according to a related art.

FIG. 2 is schematic view of a reed switch-type position indicator according to the related art.

FIG. 3 is a longitudinal cross-sectional view of an apparatus for indicating a position of a control rod in a nuclear reactor according to the present invention.

FIGS. 4A and 4B are views of sensor signal patterns when a drive rod ascends and descends by the apparatus for indicating the position of the control rod in the nuclear reactor according to the present invention, respectively.

FIG. 5 is a flowchart for explaining a method for indicating the position of the control rod in the nuclear reactor according to the present invention.

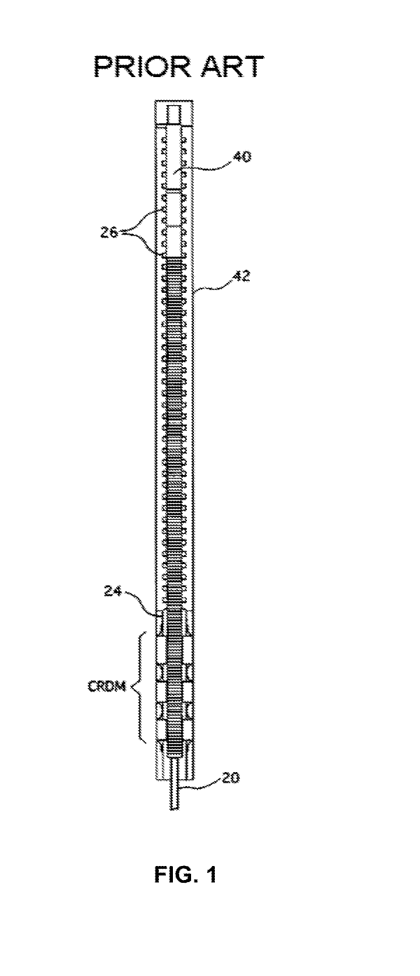

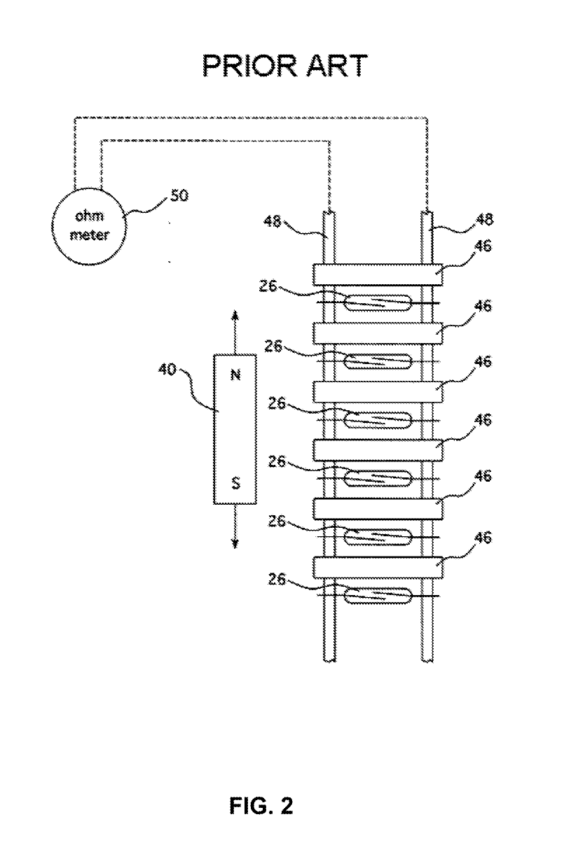

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, an apparatus and method for indicating a position of a control rod in a nuclear reactor according to the present invention will be described below in more detail with reference to the accompanying drawings.

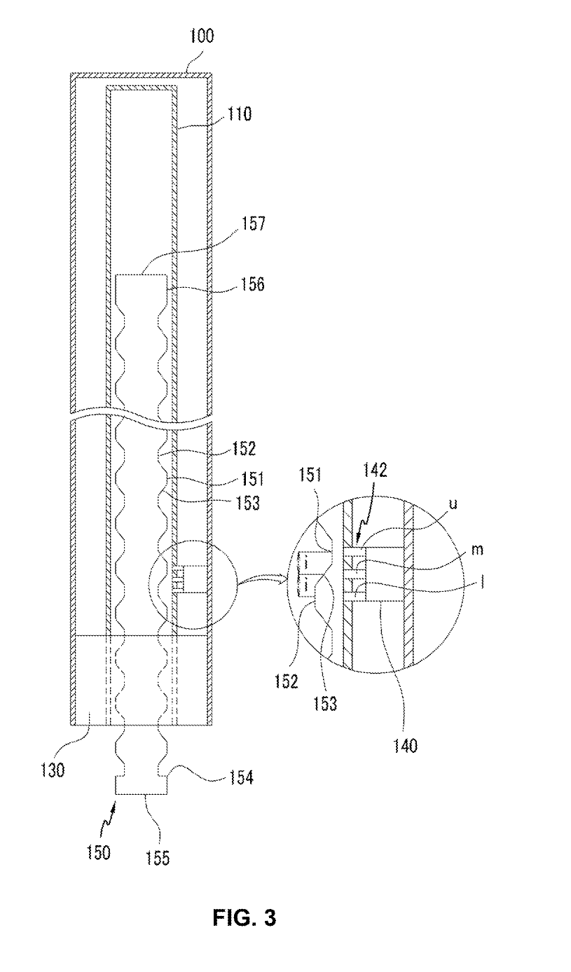

FIG. 3 is a longitudinal cross-sectional view of an apparatus for indicating a position of a control rod in a nuclear reactor according to the present invention. Referring to FIG. 3, according to the apparatus for indicating the position of the control rod in the nuclear reactor, a control rod drive rod (hereinafter, referred to as a “drive rod 150”) that is connected to a control rod assembly is elevated by a control rod drive coil not shown, i.e., a CRDM coil. The driving rod 150 is disposed within an external housing 100, e.g., a stainless steel housing consisting of a drive rod housing 110 that guides the drive rod 150 so that the drive rod 150 is smoothly elevated in a vertical direction. Thus, each of the drive rod housing 110 and the external housing 100 may have a length that is greater than the total length of at least control rod (not shown). An unevenness having a trapezoid shape (in the longitudinal cross-section) is continuously disposed in a longitudinal direction on a circumferential surface of the drive rod 150. A set of at least three (u, m, l) control rod position detection sensors 142 that will be described below may be provided to detect a convex surface 151, a concave surface 152, and an oblique surface 153, which connects the convex surface 151 to the concave surface 152, of the drive rod 150 at the same time. Next, a control unit (not shown) constituted by hardware and software may analyze pattern signals, in which pattern signals are measured at the same time by using the three sensors 142 while the control rod ascends and descends, to output the ascending/descending direction and position information of the control rod. A reference numeral 140 in the drawings represents a sensor support for supporting the control rod position detection sensor. For this, the control unit may previously store information with respect to the kind of practicable signal pattern, information with respect to the variation in signal pattern while ascending and descending, information with respect to the signal pattern in the fully descending and ascending states and then check patterns of the three sensor detection signals, which are inputted in real-time at the same time, in the memory, thereby indicating the present position of the control rod.

The control rod position detection sensor 142 may be constituted by three optical sensors that are disposed adjacent to each other, three magnetic field sensors, or three ultrasonic sensors or combination thereof. The three sensors u, m, and 1 may be vertically disposed at the same distance. In this case, lengths of the convex surface 151 and concave surface 152 and a length of the oblique surface 153 that is projected onto a vertical line, i.e., a vertical length (hereinafter, each of the lengths is referred to as a “surface length”). Here, the surface length may be equal to a distance i between the three sensors u, m, and l. A signal line (not shown) of the control rod position detection sensor 142 may be withdrawn to an upper or lateral side of the external housing 100.

A horizontal surface (hereinafter, referred to as a “lower horizontal surface 154”) instead of the oblique surface 153 is disposed on a circumferential surface that is disposed directly above a lower end surface 155 of the drive rod 150. As described below, the control rod position detection sensor 142 may check the signal pattern including the lower horizontal detection signal to indicate whether the control rod descends up to the lowermost end. The lower horizontal surface may have a length that is greater than the surface length i.

Next, the circumferential surface that is disposed directly below an upper end surface 157 of the drive rod 150 has a length greater than the surface length, i.e., a length greater than two times the surface length. As described below, the control rod position detection sensor 142 may check the signal pattern including an upper vertical detection signal to indicate the ascending of the control rod up to the uppermost end.

In Table 1 below, a kind of all signals that are outputted from the three sensors u, m, and 1 at the same time, i.e., a set of signal patterns. Here, a value “1” represents the convex surface 151, a value “0” represents the oblique surface 153, and a value “−1” represents the concave surface 152.

TABLE 1

| | Signal Pattern | |
|---|---|---|
| | (Upper, intermediate, and lower sensor | |
| Kind | signals from the top to the bottom) | Note |
| A | 1 | Being ascending/ |
| | 0 | descending |
| | −1 | |
| A⁻¹ | −1 | Being ascending/ |
| | 0 | descending |
| | 1 | |
| B | 0 | Being ascending/ |
| | −1 | descending |
| | 0 | |
| B⁻¹ | 0 | Being ascending/ |
| | 1 | descending |
| | 0 | |
| C | 0 | The lowermost end |
| | −1 | (Complete ascending) |
| | 1 | |
| D | 1 | The uppermost end |
| | 1 | (Complete descending) |
| | 0 | |

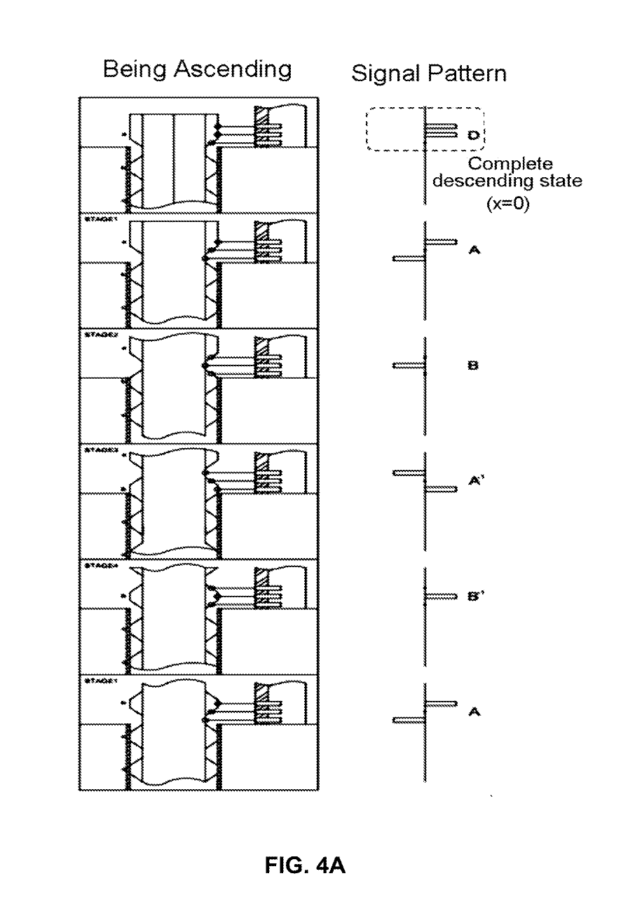

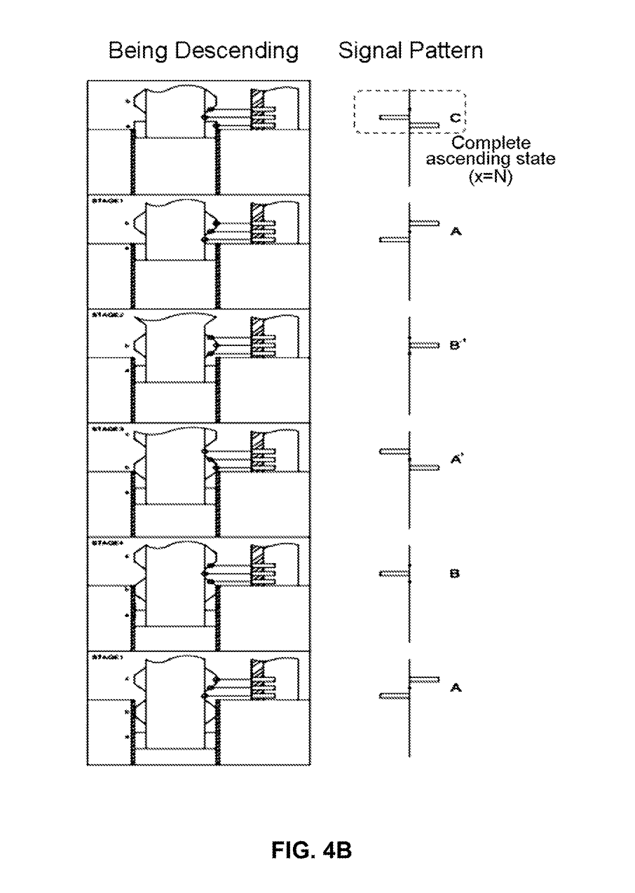

FIGS. 4A and 4B are views of sensor signal patterns when a drive rod ascends and descends by the apparatus for indicating the position of the control rod in the nuclear reactor according to the present invention, respectively. That is, FIGS. 4A and 4B illustrate various kinds of signal patterns that are shown in Table 1.

First, referring to FIG. 4A, according to the apparatus for indicating the position of the control rod in the nuclear reactor, if the control rod is ascending, the signal pattern starts at a signal pattern “D” and then repeatedly changes in order of A->B->A⁻¹->B⁻¹->A. In this process, when a signal pattern “C” that is illustrated in FIG. 4B is expressed, it is seen that the control rod completely ascends.

Next, when the control rod is descending, the signal pattern starts at the signal pattern “C” and then repeatedly changes in order of A->B⁻¹->A⁻¹->B->A. In this process, when the signal pattern “D” that is illustrated in FIG. 4A is expressed, it is seen that the control rod completely descends.

The control unit may grasp the present position of the control rod in real-time to visually display the present position or control the control rod drive coil on the basis of the present position.

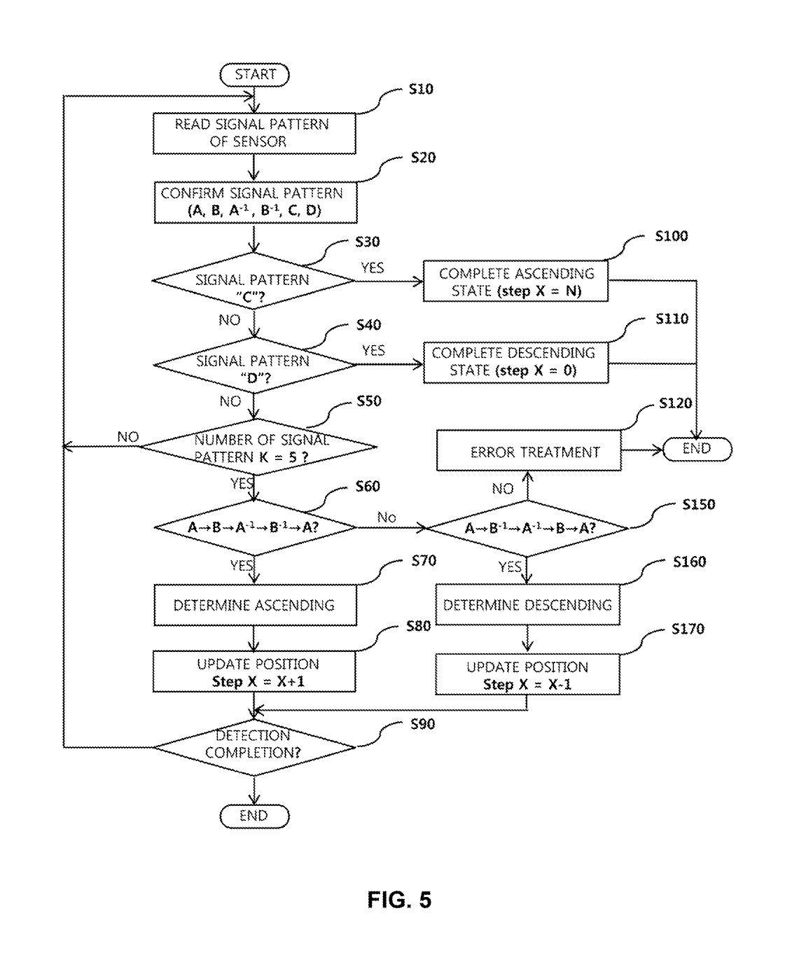

FIG. 5 is a flowchart for explaining a method for indicating the position of the control rod in the nuclear reactor according to the present invention. Here, the method for indicating the position of the control rod in the nuclear reactor may be performed by the control unit. Referring to FIG. 5, in operation S10, three detection signals that are outputted from the control rod position detection sensor 142 are read simultaneously. In operation S20, the read signal pattern may be inquired in a memory to confirm a kind of read signal pattern, i.e., one of signal patterns A, A⁻¹, B, B⁻¹, C, and D.

In operation S30, whether a kind of confirmed signal pattern corresponds to the signal pattern “C” is checked. If the kind of confirmed signal pattern corresponds to the signal pattern “C”, the state in which the present control rod completely ascends is confirmed (in the operation S100). Then, the completely ascending state may be displayed, and program may be ended. In the result checked in the operation S30, if the kind of signal pattern does not correspond to the signal pattern “C”, the process may proceed to operation S40 to check whether a kind of signal pattern corresponds to the signal pattern “D”.

According to the result checked in the operation S40, if the kind of signal pattern corresponds to the signal pattern “D”, the state in which the present control rod completely descends is confirmed (the operation S110). Then, the completely descending state may be displayed, and the program may be ended. According to the result checked in the operation S40, if the kind of signal pattern does not correspond to the signal pattern “D”, the process may proceed to operation s50 to determine whether the number K of collected signal patterns reaches five. This process may be performed because the ascending and descending of the control rod are surely determined when continuous five signal patterns are collected (theoretically, it is possible to determine the ascending and descending of the control rod when only two signal patterns are collected). Here, when the number K of signal patterns initially reaches five, if a new signal pattern is collected, the oldest signal pattern may be removed first. That is, only the five signal patterns that are initially collected in a first-in & first-out manner may be used.

According to the result determined in the operation S50, if the number K of signal patterns is less than five, the process returns to the operation S10. On the other hand, if the number K of signal patterns reaches five, whether the collected signal patterns are arranged in order of A->B->A⁻¹->B⁻¹->A, i.e., whether an order of the collected signal patterns corresponds to one of orders (A->B->A⁻¹->B⁻¹->A), (B->A⁻¹->B⁻¹->A->B), (A⁻¹->B⁻¹->A->B->A⁻¹), and (B⁻¹->A->B->A⁻¹->B⁻¹) is checked. According to the result checked in the operation S50, when the signal patterns are arranged in order of A->B->A⁻¹->B⁻¹->A, the process may proceed to operation S70 to confirm that the control rod is ascending. In operation S80, the present position of the control rod may be updated, i.e., the ascending of the control rod by a first step (corresponding to the surface length) may be updated to confirm the ascending of the control rod (where, step X=X+1).

Next, whether all detections are completed is determined in operation S90. If the detections are not completed, the process may return to operation S10. On the other hand, if the detections are completed, the program may be ended.

According to the result determined in the operation S60, if the collected signal patterns are not arranged in order of A->B->A⁻¹->B⁻¹->A, the process may proceed to operation S150 to check whether the collected signal patterns are arranged in order of A->B⁻¹->A⁻¹->B->A, i.e., whether the collected signal patterns are arranged in one of orders (A->B⁻¹->A⁻¹->B->A), (B⁻¹->A⁻¹->B->A->B⁻¹), (A⁻¹->B->A->B⁻¹->A⁻¹), and (B->A->B⁻¹->A⁻¹->B). According to the result checked in the operation S150, when the signal patterns are arranged in order of A->B⁻¹->A⁻¹->B->A, the process may proceed to operation S160 to confirm that the control rod is descending. In operation S170, the present position of the control rod may be updated, i.e., the descending of the control rod by a first step (corresponding to the surface length) may be updated to confirm the descending of the control rod (where, step X=X−1).

In the result checked in the operation S150, if the signal patterns are not arranged in order of A->B⁻¹->A⁻¹->B->A, the process may proceed to operation S120 to end the program after error treatment is performed.

Although the apparatus and method for indicating the position of the control rod in the nuclear reactor according to the present invention are described above with reference to the accompanying drawings, the embodiments are only preferred embodiments of the present invention, and it should be apparent to those having ordinary skill in the art that various changes, modifications, or alterations to the invention as described herein may be made. Hence, the real protective scope of the present invention shall be determined by the technical scope of the accompanying claims.

For example, a triangular unevenness or sine wave-shaped unevenness instead of the trapezoid unevenness may be used. In this case, the values “1”, “0”, and “−1” may not be provided as fixed values, but be provided as a category (hereinafter, the trapezoid unevenness, the triangular unevenness, and the sine wave-shaped unevenness are called “the oblique unevenness”). Furthermore, the trapezoid unevenness may be locally disposed on only a side surface on which the control rod position detection sensor 142 is disposed, but be disposed over the entire circumferential surface of the drive rod as necessary.

According to the apparatus and method for indicating the position of the control rod in the nuclear reactor, while the electrical signal generation sensor that is relatively sensitive to the external environments is minimally used, the control rod drive rod that is relatively insensitive to the external environments may be properly designed in shape to indicate the position of the control rod. Thus, the apparatus for indicating the position of the control rod may be simplified in structure and stably and precisely indicate the position of the control rod.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for indicating a position of a control rod in a nuclear reactor, which comprises a control rod drive rod that is connected to a control rod assembly so as to be elevated by a control rod drive coil, the apparatus comprising:
the control rod drive rod on which an oblique unevenness is continuously disposed along a longitudinal direction of a circumferential surface thereof;
at least three drive rod position detection sensors that detect a convex portion, a concave portion, and an oblique portion of the oblique unevenness at the same time; and
a control unit analyzing a pattern of detection signals that are outputted from the drive rod position detection sensors at the same time to indicate the position of the control rod.

2. The apparatus of claim 1, wherein the oblique unevenness comprises an unevenness having a trapezoid shape,
the convex portion, the concave portion, and the oblique portion correspond to a convex surface, a concave surface, and an oblique surface of the trapezoid shape, respectively, and
each of lengths of the convex surface, the concave surface and a vertical length of the oblique surface is equal to each of distances between the three drive rod position detection sensors.

3. The apparatus of claim 2, wherein a horizontal surface instead of the oblique surface is disposed on a circumferential surface of the control rod drive rod, which is disposed directly above a lower end surface of the control rod drive rod, and
a circumferential surface of the control rod drive rod, which is disposed directly below an upper end surface of the control rod drive rod, has a length greater than that of the convex surface.

4. The apparatus of any one of claim 1, wherein the three control rod position detection sensors are constituted by an exclusive optical sensor, magnetic field sensor, or ultrasonic sensor or a combination thereof.

5. A method for indicating a position of a control rod in a nuclear reactor, which is performed by a control unit in the nuclear reactor comprising: a control rod drive rod that is connected to a control rod assembly so as to be elevated by a control rod drive coil and on which an oblique unevenness is continuously disposed along a longitudinal direction of a circumferential surface thereof; and at least three drive rod position detection sensors that detect a convex portion, a concave portion, and an oblique portion of the oblique unevenness at the same time, the method comprising:
a process (a) of checking a pattern of three signals that are outputted from the drive rod position detection sensors at the same time; and
a process (b) of indicating whether the control rod is elevated on the basis of a kind of signal pattern and variation of the signal pattern.

6. The method of claim 5, wherein the signal pattern when the control rod drive rod is disposed at the uppermost end or lowermost end is different from that when the signal pattern is not disposed at the uppermost end or lowermost end.

7. The method of claim 5, wherein an absolute position of the control rod is grasped on the basis of the number of variation of the signal pattern.
